(19) United States
(12) Patent Application Publication
(10) Pub. No.: US 2011/0122080 A1
(43) Pub. Date: May 26, 2011

(54) ELECTRONIC DEVICE, DISPLAY CONTROL METHOD, AND RECORDING MEDIUM

(76) Inventor: Shinichi KANJIYA, Osaka (JP)

(21) Appl. No.: 12/950,393

(22) Filed: Nov. 19, 2010

(30) Foreign Application Priority Data
Nov. 20, 2009 (JP) 2009-265293(P)

(51) Int. Cl. G06F 3/041

(52) U.S. Cl. 345/173

(57) ABSTRACT

An electronic device including the touch panel display formed of a combination of a touch panel and a display, and accepting single-point input and multi-point input to the touch panel includes an input point number detection unit detecting the number of input points to the touch panel, based on contact of an object with the touch panel, a storage device storing first association information associating point number information about the number of input points with attribute information about an attribute of a line to be used for drawing, an attribute setting unit setting an attribute of the line, based on the detected number of input points and the first association information, and a display control unit causing the display to display an image by means of the line having the set attribute and in accordance with input to the touch panel.

This nonprovisional application is based on Japanese Patent Application No. 2009-265293 filed on Nov. 20, 2009 with the Japan Patent Office, the entire contents of which are hereby incorporated by reference.

### BACKGROUND OF THE INVENTION

1. Field of the Invention

The present invention relates to an electronic device, a display control method, and a recording medium. In particular, the present invention relates to an electronic device including a touch panel display, a display control method for the electronic device, and a recording medium having a program recorded thereon for controlling the electronic device.

2. Description of the Background Art

A touch panel display in which a touch panel and a display are combined (also called “touch screen”) has conventionally been known.

Japanese National Patent Publication No. 2005-529414 (hereinafter referred to as “Patent Document 1”) discloses an apparatus including a touch screen. In the apparatus, input components for providing an excitation electromagnetic field to a cordless pen and for sensing the cordless pen and a user's finger are integrated in a display. The apparatus allows a plurality of icons representing virtual user buttons to be displayed on the display. One virtual user button is selected by a user placing a finger of the user's left hand against the display within an area of the display in which the button is displayed. The display includes a writing area. The writing area is an area in which virtual writing, drawing, or other patterning created by a user moving a pen or stylus over the area is displayed at the locations where the user moves the pen.

Japanese Patent Laying-Open No. 04-177518 (hereinafter referred to as “Patent Document 2”) discloses a color drawing apparatus as the above-described touch panel display. Regarding the color drawing apparatus, a color selection switch provided on a pen is operated to designate a color to be displayed by display means. After this, the pen is moved while being in contact with location sensing means, and the color drawing apparatus accordingly senses the coordinates of the location. The color drawing apparatus allows the display means to display an image based on the data about the coordinates and the designated color.

Patent Document 2 further discloses another color drawing apparatus as the above-described touch panel display. Regarding the color drawing apparatus, a user uses a pen to touch one of four switches provided on a tablet of the apparatus and thereby select a color.

Japanese Patent Laying-Open No. 09-054649 (hereinafter referred to as “Patent Document 3”) discloses, as the above-described touch panel, an information processor including coordinate detection means for detecting a designated coordinate position, writing pressure detection means for detecting a writing pressure applied when the coordinate position is designated, display means capable of displaying characters and figures for example, and drawing means for drawing a cursor on the display means. The cursor drawing means draws on the display means a cursor of a shape and/or size in accordance with the writing pressure detected by the writing pressure detection means, at the position corresponding to the coordinates detected by the coordinate detection means.

For a touch panel display having a drawing capability, a user selects each of icons representing for example line thickness, line type, line color, and the shape of a figure, respectively, to thereby select a thickness, a type, and a color of a line of an image to be drawn as well as a shape of a figure to be drawn.

### SUMMARY OF THE INVENTION

Regarding the apparatus of Patent Document 1, a user has to select one button with a finger from a plurality of virtual user buttons. Regarding the color drawing apparatus of Patent Document 2, it is required for selection of a color to operate the color selection switch provided on the pen or select a switch provided on the tablet. As for the information processor of Patent Document 3, a user is required to change the writing pressure for changing the shape and/or size of a cursor to be drawn. Further, regarding the touch panel display having the drawing capability, a user is required to perform an operation of selecting an icon.

According to an aspect of the present invention, an electronic device includes a touch panel display formed of a combination of a touch panel and a display, and accepts single-point input and multi-point input to the touch panel. The electronic device includes: a first detection unit configured to detect the number of input points to the touch panel, based on contact of an object with the touch panel; a storage device storing first association information associating point number information about the number of input points with attribute information about an attribute of a line to be used for drawing; a setting unit configured to set an attribute of the line to be used for drawing, based on the detected number of input points and the first association information; and a display control unit configured to cause the display to display an image by means of the line having the set attribute and in accordance with input to the touch panel.

Preferably, the electronic device further includes a second detection unit configured to detect a contact position of the object with the touch panel, based on contact of the object with the touch panel, and a determination unit configured to determine, when the input points are multiple input points, and based on the detected contact position, whether alignment of detected contact positions extends along a predetermined direction. The attribute information includes line width information about a line width. When it is determined that the alignment extends along the predetermined direction, the setting unit sets, based on the point number information and the line width information, the line width of the line to be used for drawing to a width in accordance with the detected number of input points.

Preferably, the electronic device further includes a second detection unit configured to detect a contact position of the object with the touch panel, based on contact of the object with the touch panel, and a determination unit configured to determine, when the input points are multiple input points, whether alignment of detected contact positions extends along a predetermined direction based on the detected contact position. The attribute information includes line type information about a line type. The line type information includes at least information about a first line type and information about a second line type. When it is determined that the alignment extends along the predetermined direction, the setting unit sets the line type of the line to be used for drawing to the first line type based on the line type information. When it is determined that the alignment does not extend along the predetermined direction, the setting unit sets the line type of the line to be used for drawing to the second line type based on the line type information.

Preferably, the attribute information further includes line width information about a line width. The setting unit sets, based on the point number information and the line width information, the line width of the line to be used for drawing to a width in accordance with the detected number of input points.

Preferably, the electronic device further includes a determination unit configured to determine whether the contact of the object is made for not less than a predetermined time. The attribute information further includes color information about a line color. When it is determined that the contact of the object is made for not less than the predetermined time, the setting unit sets, based on the point number information and the color information, the color of the line to be used for drawing to a color in accordance with the detected number of input points. When it is determined that the contact of the object is not made for not less than the predetermined time, the setting unit sets the color of the line to be used for drawing to a predetermined color.

Preferably, the electronic device further includes a count unit configured to count the number of times the single-point input is successively performed in such a manner that, when a time interval between the single-point input and a subsequent single-point input is within a predetermined time, the subsequent single-point input is counted. The storage device further stores second association information associating the number of times with a figure to be used for drawing. The setting unit sets a figure to be drawn, based on the counted number of times and the second association information. The display control unit causes the display to display an image in accordance with the set figure.

According to another aspect of the present invention, a display control method for an electronic device including a touch panel display formed of a combination of a touch panel and a display, and accepting single-point input and multi-point input to the touch panel is provided. The display control method includes the steps of: detecting, by a processor of the electronic device, the number of input points to the touch panel, based on contact of an object with the touch panel; setting, by the processor, an attribute of a line to be used for drawing, based on association information associating point number information about the number of input points with attribute information about an attribute of the line to be used for drawing, as well as the detected number of input points; and causing, by the processor, the display to display an image by means of the line having the set attribute and in accordance with input to the touch panel.

According to still another aspect of the present invention, a recording medium having a program recorded thereon for controlling an electronic device including a touch panel display formed of a combination of a touch panel and a display and accepting single-point input and multi-point input to the touch panel is provided. The program causes the electronic device to execute the steps of: detecting the number of input points to the touch panel, based on contact of an object with the touch panel; setting an attribute of a line to be used for drawing, based on association information associating point number information about the number of input points with attribute information about an attribute of the line to be used for drawing, as well as the detected number of input points; and causing the display to display an image by means of the line having the set attribute and in accordance with input to the touch panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an external view of an electronic device.

FIG. 2 is a diagram showing a hardware configuration of the electronic device.

FIG. 3 is a diagram for illustrating a user's operation performed to set the width of a line to be drawn on a display.

FIG. 4 is a diagram for illustrating a user's operation performed to set the type of a line to be drawn on a display.

FIG. 5 is a diagram for illustrating a user's operation performed to set the color of a line to be drawn on a display.

FIG. 6 is a diagram for illustrating a user's operation performed to set the type of a figure to be drawn on a display.

FIG. 7 is a diagram mainly for illustrating functional blocks of the electronic device.

FIG. 8 is a diagram for illustrating a data structure of first association information.

FIG. 9 is a diagram for illustrating a data structure of second association information.

FIG. 10 is a flowchart showing a part of a flow of processing in an electronic device 1.

FIG. 11 is a flowchart showing a remaining part of the flow of the processing in the electronic device 1 that is not shown in FIG. 10.

### DESCRIPTION OF THE PREFERRED EMBODIMENTS

An electronic device according to an embodiment of the present invention will hereinafter be described with reference to the drawings. In the following description, the same components are denoted by the same reference characters. They are named and function identically. Therefore, a detailed description thereof will not be repeated. Specific examples of the electronic device include mobile phone, PDA (Personal Digital Assistant), electronic dictionary, and PC (Personal Computer).

### External Appearance

FIG. 1 is a diagram showing an external appearance of the electronic device according to the present embodiment, Referring to FIG. 1, electronic device 1 includes a touch panel display 10. Touch panel display 10 is an electronic device in which a display and a touch panel are combined. The touch panel is a position input device.

### Hardware Configuration

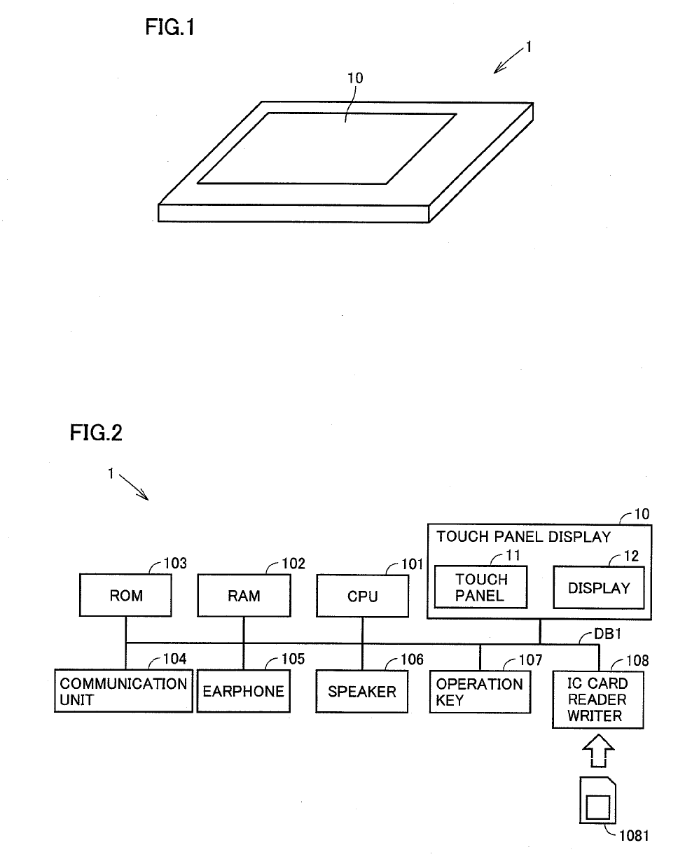

FIG. 2 is a diagram showing a hardware configuration of electronic device 1. Referring to FIG. 2, electronic device 1 includes, as main components, touch panel display 10, a CPU (Central Processing Unit) 101 executing a program, a RAM (Random Access Memory) 102, a ROM (Read Only Memory) 103 storing data in a non-volatile manner, an earphone 105, a speaker 106, an operation key 107 receiving an instruction input of a user of electronic device 1, and an IC (Integrated Circuit) card reader writer 108. RAM 102 stores data generated through execution of a program by CPU 101 or data that is input via operation key 107.

Touch panel display 10 includes a touch panel 11 and a display 12. Touch panel 11 accepts not only single-point input but also multi-point input. A user can thus designate a plurality of locations on the screen simultaneously and independently of each other.

Components 10 and 101 to 108 are connected to each other by a data bus DB1. On IC card reader writer 108, a memory card 1081 is mounted. In the following, a description will be given of an example where RAM 102 is a flash memory (nonvolatile semiconductor memory).

Processing in electronic device 1 is implemented by each hardware and software executed by CPU 101. Such software may be stored in advance in RAM 102 or ROM 103. The software may also be stored in memory card 1081 or another recording medium, and may be distributed in the form of a program product. Alternatively, the software may be supplied by a so-called information provider connected to the Internet in the form of a downloadable program product. Such software is read from the recording medium by IC card reader writer 108 or another reading device or downloaded through a communication IF, and thereafter stored temporarily in RAM 102. The software is then read from RAM 102 by CPU 101, and further stored in the form of an executable program in RAM 102. CPU 101 executes the program.

The components constituting electronic device 1 shown in FIG. 2 are each a commonly used one. Therefore, an essential part of the present invention may be said to be software stored in RAM 102, memory card 1081 or another recording medium, or software downloadable through a network. Since the operation of each hardware of electronic device 1 is well known, a detailed description thereof will not be repeated.

The recording medium is not limited to DVD-ROM, CD-ROM, FD (Flexible Disk), or hard disk, and may be magnetic tape, cassette tape, optical disc (MO (Magnetic Optical Disc)/MD (Mini Disc)/DVD (Digital Versatile Disc)), optical card, or semiconductor memory such as mask ROM, EPROM (Electronically Programmable Read Only Memory), EEPROM (Electronically Erasable Programmable Read Only Memory), or flash ROM that holds a program in a fixed manner. The recording medium is a non-temporary medium from which the program or the like can be read by a computer.

The program herein includes not only a program that can be executed directly by the CPU but also a program in the form of a source program, a compressed program, an encrypted program, and the like.

### Overview

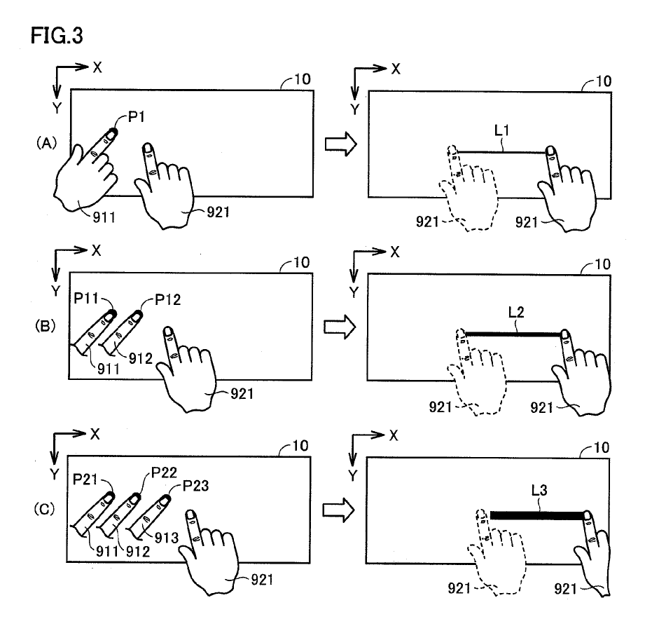

Referring to FIGS. 3 to 6, an operational overview of electronic device 1 will now be described. Electronic device 1 has a capability of enabling a touch operation (contact) of an object (finger, stylus pen or the like) against touch panel 11 to create a drawing on display 12 based on the touch position. In the following, a description will be given of an example where electronic device 1 executes a program for implementing the drawing capability.

Setting of Line Width

FIG. 3 is a diagram for illustrating a user's operation performed to set the width of a line to be drawn on display 12. FIG. 3(A) illustrates a user's operation performed to draw a line of a thin line width. FIG. 3(B) illustrates a user's operation performed to draw a line of a middle line width. FIG. 3(C) illustrates a user's operation performed to draw a line of a thick line width,

Referring to FIG. 3(A), when a user performs single-point input for a contact time shorter than time T1, electronic device 1 sets the width of a line to be used for drawing to “thin”. More specifically, in the case where a user brings a finger 911 into contact with touch panel 11 at an arbitrary position P1 thereon, electronic device 1 draws a line L1 of a thin line width based on the subsequent contact with a finger 921 or stylus pen.

Referring to FIG. 3(B), when a user performs two-point input along the x-axis direction for a contact time shorter than time T1, electronic device 1 sets the width of a line to be used for drawing to “middle”. More specifically, in the case where a user brings fingers 911, 912 into contact with touch panel 11 at positions P11, P12 thereon simultaneously, electronic device 1 draws a line L2 of a middle line width based on the subsequent contact with finger 921 or stylus pen.

Referring to FIG. 3(C), when a user performs three-point input along the x-axis direction for a contact time shorter than time T1, electronic device 1 sets the width of a line to be used for drawing to “thick”. More specifically, in the case where a user brings fingers 911, 912, 913 to be in contact with touch panel 11 at positions P21, P22, P23 thereon simultaneously, electronic device 1 draws a line L3 of a thick line width based on the subsequent contact with finger 921 or stylus pen.

Electronic device 1 in FIG. 3(A) to (C) sets the line type to a default line type (solid line in the present embodiment), and sets the line color to a default color (black in the present embodiment). The line width of lines L1, L2, L3 each is determined in advance for electronic device 1. Each line width can be changed at user's instruction.

Setting of Line Type

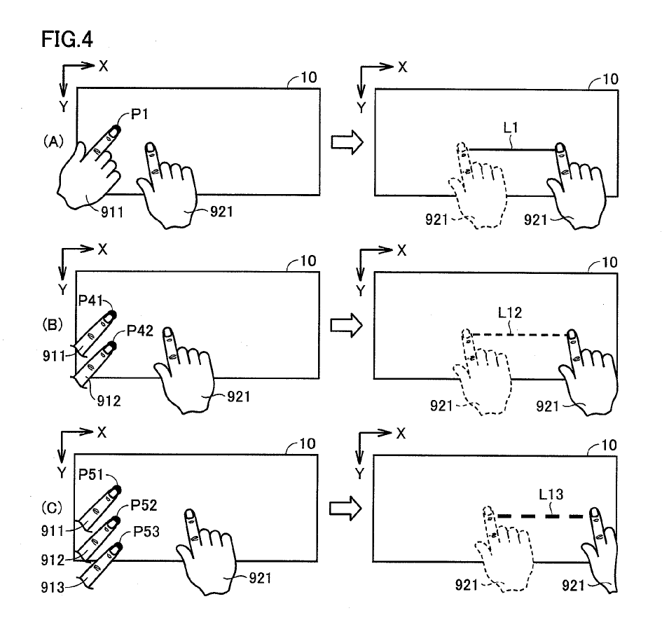

FIG. 4 is a diagram for illustrating a user's operation performed to set the line type of a line to be drawn on display 12. The line type may include, for example, solid line, broken line, dotted line, chain line, and chain double-dashed line.

FIG. 4(A) illustrates a user's operation performed to draw a thin solid line. Namely, this operation is identical to the user's operation shown in FIG. 3(A). FIG. 4(B) illustrates a user's operation performed to draw a thin broken line. FIG. 4(C) illustrates a user's operation performed to draw a broken line of a middle line width.

Referring to FIG. 4(A), when a user performs single-point input for a contact time shorter than time T1, electronic device 1 sets the line width to “solid line” and the line width to “thin” for a line to be used for drawing. In this case, as described above, electronic device 1 draws line L1 of a thin line width based on the subsequent contact with finger 921 or stylus pen.

Referring to FIG. 4(B), when a user performs two-point input along the y-axis direction for a contact time shorter than time T1, electronic device 1 sets the line type to “broken line” and the line width to “thin” for a line to be used for drawing. More specifically, in the case where a user brings fingers 911, 912 into contact with touch panel 11 at positions P41, P42 thereon simultaneously, electronic device 1 draws a broken line L12 of a thin line width based on the subsequent contact with finger 921 or stylus pen. The x-axis and the y-axis are orthogonal to each other.

Referring to FIG. 4(C), when a user performs three-point input along the y-axis direction for a contact time shorter than time T1, electronic device 1 sets the line type to “broken line” and the line width to “middle” for a line to be used for drawing. More specifically, in the case where a user brings fingers 911, 912, 913 into contact with touch panel 11 at positions P51, P52, P53 thereon simultaneously, electronic device 1 draws a broken line L13 of a middle line width, based on the subsequent contact with finger 921 or stylus pen.

The line type of lines L12, L13 is determined in advance for electronic device 1. The line type can be changed at a user's instruction. For example, at a user's instruction to change the line type from the broken line to the dotted line, electronic device 1 changes the line type from the broken line to the dotted line.

Setting of Line Color

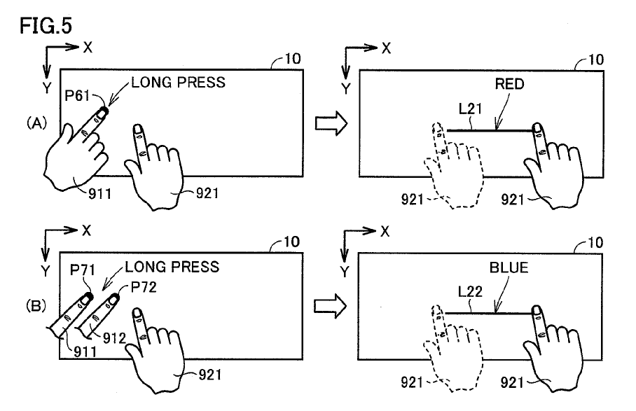

FIG. 5 is a diagram for illustrating a user's operation performed to set the color of a line to be drawn on display 12. FIG. 5(A) illustrates a user's operation performed to draw a red line. FIG. 5(B) illustrates a user's operation performed to draw a blue line.

Referring to FIG. 5(A), when a user performs single-point input for a contact time equal to or longer than time T1, electronic device 1 sets the color of a line to be used for drawing to “red”. More specifically, in the case where a user brings finger 911 into contact with touch panel 11 at an arbitrary position P61 thereon, electronic device 1 draws a red and thin solid line L21 based on the subsequent contact with finger 921 or stylus pen.

Referring to FIG. 5(B), when a user performs two-point input for a contact time equal to or longer than time T1, electronic device 1 sets the color of a line to be used for drawing to “blue”. More specifically, in the case where a user brings fingers 911, 912 into contact with touch panel 11 at positions P71, P72 thereon simultaneously, electronic device 1 draws a blue and thin solid line L22 based on the subsequent contact with finger 921 or stylus pen. The two-point input may be input along the x-axis direction or input along the y-axis direction. The input direction of the two-point input is not particularly limited.

In electronic device 1, the line color for the manner of contact in FIG. 5(A) and the line color for the manner of contact in FIG. 5(B) are determined in advance. The line color for each manner of contact can be changed at a user's instruction.

Setting of Figure Type

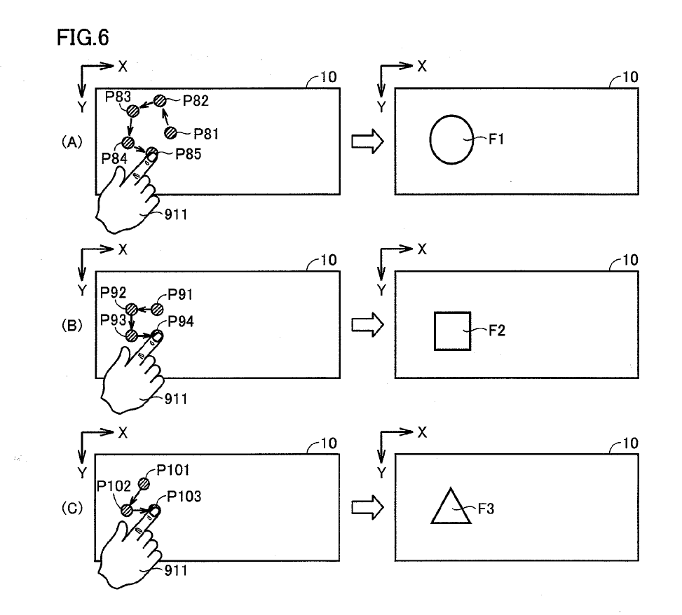

FIG. 6 is a diagram for illustrating a user's operation performed to set the type of a figure to be drawn on display 12. FIG. 6(A) illustrates a user's operation performed to draw a circle. FIG. 6(B) illustrates a user's operation performed to draw a rectangle. FIG. 6(C) illustrates a user's operation performed to draw a triangle.

Referring to FIG. 6(A), when a user successively performs single-point input for a contact time shorter than time T1 five times or more, electronic device 1 draws a circle F1 on display 12. More specifically, in the case where a user brings finger 911 into contact with touch panel 11 successively at positions P81, P82, P83, P84, P85 thereon in this order, electronic device 1 draws circle F1 at a position and of a size, in accordance with these positions. The space between the adjacent positions of positions P81 to P85 is a predetermined space, which will be described later herein.

Referring to FIG. 6(B), when a user successively performs single-point input for a contact time shorter than time T1 four times, electronic device 1 draws a rectangle F2 on display 12. More specifically, in the case where a user brings finger 911 into contact with touch panel 11 successively at positions P91, P92, P93, P94 thereon in this order, electronic device 1 draws rectangle F2 at a position and of a size, in accordance with these positions. The space between the adjacent positions of positions P91 to P94 is a predetermined space, which will be described later herein.

Referring to FIG. 6(C), when a user successively performs single-point input for a contact time shorter than time T1 three times, electronic device 1 draws a triangle F3 on display 12. More specifically, in the case where a user brings finger 911 into contact with touch panel 11 successively at positions P101, P102, P103 thereon in this order, electronic device 1 draws triangle F3 at a position and of a size, according to these positions. The space between the adjacent positions of positions P101 to P103 is a predetermined space, which will be described later herein.

Electronic device 1 in FIG. 6(A) to (C) sets the line width to a default width (thin in the present embodiment), sets the line type to a default line type (solid line in the present embodiment), and sets the line color to a default color (black in the present embodiment). The line width of lines L1, L2, L3 each is determined in advance for electronic device 1. Each line width can be changed at user's instruction.

A specific configuration of electronic device 1 for implementing the operations shown in FIGS. 3 to 6 will now be described.

### Block Diagram and Data Structure

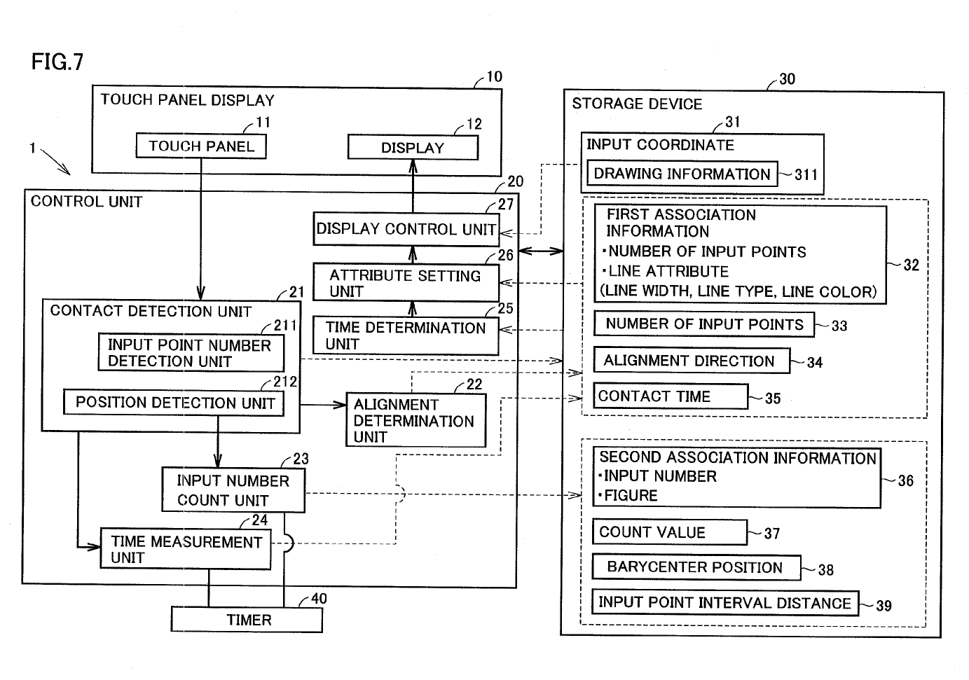

FIG. 7 is a diagram mainly for illustrating functional blocks of electronic device 1. Referring to FIG. 7, electronic device 1 includes touch panel display 10, a control unit 20, a storage device 30, and a timer 40. Control unit 20 includes a contact detection unit 21, an alignment determination unit 22, an input number count unit 23, a time measurement unit 24, a time determination unit 25, an attribute setting unit 26, and a display control unit 27. Contact detection unit 21 includes an input point number detection unit 211 and a position detection unit 212.

Control unit 20 and units 21 to 26, 211, and 212 included in control unit 20 are functional blocks. Specifically, each functional block is implemented through execution of a program stored in RAM 102 and/or ROM 103 by CPU 101. Each functional block can also be implemented by hardware.

Storage device 30 stores an input coordinate 31, first association information 32, an input point number 33, an alignment direction 34, a contact time 35, second association information 36, a count value 37, a barycenter position 38, and an input point interval distance 39. As a piece of information about input coordinate 31, storage device 30 stores drawing information. First association information 32 and second association information 36 are stored in advance in storage device 30 at the time of shipment from a factory of electronic device 1. Storage device 30 is constituted of RAM 102 and ROM 103.

Timer 40 informs control unit 20 of time information.

Contact detection unit 21 detects contact of a finger or stylus pen with touch panel 11. Input point number detection unit 211 detects, based on contact of a finger for example with touch panel 11, the number of input points to touch panel 11. Position detection unit 212 detects, based on contact of a finger for example with touch panel 11, the position where the finger contacts touch panel 11. Contact detection unit 21 stores in storage device 30 the detected position of contact in the form of an input coordinate. Contact detection unit 21 also stores in storage device 30 the detected number of input points.

When there are multiple input points, alignment determination unit 22 determines, based on contact positions detected by position detection unit 212, whether the alignment of the contact positions extends along a predetermined direction. Specifically, alignment determination unit 22 determines whether the alignment of the contact positions extends along the x-axis or y-axis direction. Here, alignment determination unit 22 converts the alignment of the contact positions into a straight line, for example, and determines, based on the angle formed by the straight line and the x-axis or y-axis, whether the alignment of the contact positions extends along the x-axis or y-axis. The way in which alignment determination unit 22 makes this determination is not limited to the above-described one. Alignment determination unit 22 stores the determined direction of the alignment in storage device 30.

Time measurement unit 24 measures the contact time of a finger for example. Time measurement unit 24 uses as a trigger the fact that contact detection unit 21 detects contact, and calculates the contact time based on the time information from timer 40. Time measurement unit 24 stores the measured contact time in storage device 30.

Input number count unit 23 counts the number of times single-point input (input shorter than time T1) is successively done multiple times at an interval within a predetermined time T2. Input number count unit 23 stores the input number, namely the number of times the input is done, in storage device 30 as the above-described count value. Input number count unit 23 determines, based on the information from timer 40, whether each time interval at which single-point input is done is within predetermined time T2.

By way of example, a description will be given based on FIG. 6(A). In this case, input number count unit 23 stores a count value of “5” in storage device 30. In the case where a description is given based on FIG. 3(A), when the time interval between contact of finger 911 and contact of finger 921 is within above-described time T2, input number count unit 23 stores a count value of “2” in storage device 30.

Time determination unit 25 determines, based on the information about the above-described contact time stored in storage device 30, whether the contact continues for not less than above-described time T1. Time determination unit 25 sends the result of the determination to attribute setting unit 26.

Attribute setting unit 26 sets, based on the information stored in storage device 30, attributes of a line to be used for drawing. Here, the attributes of a line refer to properties for defining a line, such as line width, line type, and line color. Attribute setting unit 26 also sets a figure to be drawn, based on the information stored in storage device 30. Examples of the figure to be set include triangle, rectangle, and circle shown in FIG. 6. In the following description of detailed processing of attribute setting unit 26, a description will be given first of first association information 32 and second association information 36 stored in storage device 30.

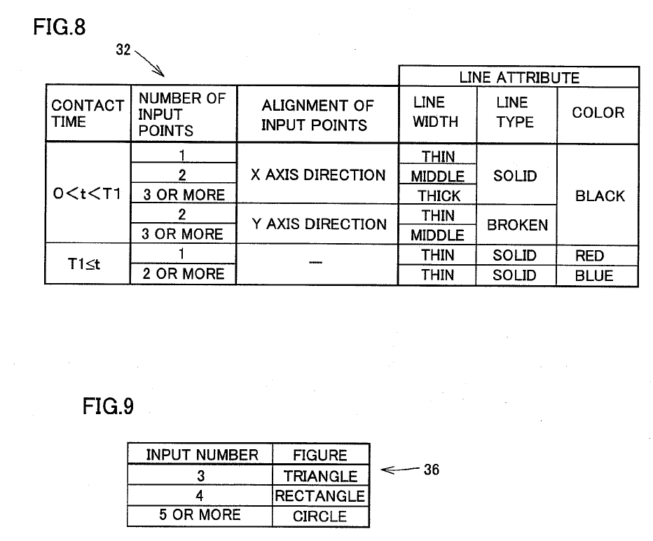

FIG. 8 is a diagram for illustrating a data structure of first association information 32. Referring to FIG. 8, in first association information 32, information about contact time, point number information about the number of input points, alignment information about alignment of an input template, and attribute information about line attributes are associated with each other. The attribute information includes line width information about the line width, line type information about the line type, and color information about the line color.

In first association information 32, the case for example where the contact time is shorter than time T1, the number of input points is 2, and the alignment of the input points extends in the x-axis direction is associated with information items such as the line width “middle”, the line type “solid”, and the line color “black”. Further, in first association information 32, the case for example where the contact time is not shorter than T1 and the number of input points is 1 is associated with information items such as the line width “thin”, the line type “solid”, and the line color “red”.

In FIG. 8, “thin”, “middle”, and “thick” are associated respectively with specific numerical values representing respective line widths. Electronic device 1 is configured to allow a user's operation to change the numerical values.

FIG. 9 is a diagram for illustrating a data structure of second association information 36. Referring to FIG. 9, in second association information 36, information about the input number and information about the figure are associated. In second association information 36, for example, the input number 3 is associated with the figure of a triangle.

Attribute setting unit 26 uses first association information 32 and second association information 36 to set attributes of a line to be drawn and a figure to be drawn. Attribute setting unit 26 selects, based on the count value, setting of the attributes of a line to be drawn or the setting of the figure to be drawn. Specifically, attribute setting unit 26 sets the figure to be drawn when the count value is not less than 3, and sets the attributes of a line to be drawn when the count value is less than 3.

In the following, a description will be given first of a case where attribute setting unit 26 sets attributes of a line to be drawn. Next, a description will be given of a case where attribute setting unit 26 sets a figure to be drawn.

Attribute setting unit 26 switches processing based on the result of determination made by time determination unit 25. Specifically, when the contact time is shorter than time T1, attribute setting unit 26 sets the line width and the line type to those conforming to the state of contact, based on first association information 32. When the contact time is not shorter than T1, attribute setting unit 26 sets the line color to the one conforming to the state of contact.

Processing will be described first of attribute setting unit 26 in the case where time determination unit 25 determines that the contact time is shorter than time T1. Attribute setting unit 26 sets the attributes of a line to be used for drawing, based on the number of input points detected by contact detection unit 21 and first association information 32. Namely, attribute setting unit 26 sets the line attributes (line width, line type, line color), based on input point number 33 and first association information 32 stored in the storage device.

More specifically, in the case where it is determined that the alignment extends along the x-axis direction, attribute setting unit 26 sets, based on the input point number information and the line width information in first association information 32, the line width of a line to be used for drawing to a width based on detected input point number 33. Attribute setting unit 26 also sets, in the case where the alignment extends along the x-axis direction, the line type of a line to be used for drawing, based on the line type information in first association information 32. For example, when detected input point number 33 has a value of “2”, attribute setting unit 26 sets the line width to “middle”, the line type to “solid” and the line color to “black”, based on first association information 32.

In contrast, when it is determined that the alignment extends along the y-axis direction, attribute setting unit 26 sets, based on the line type information in first association information 32, the line type of a line to be used for drawing. Further, attribute setting unit 26 sets, based on the point number information and the line width information in first association information 32, the line width of a line to be used for drawing to a width based on input point number 33. For example, when detected input point number 33 has a value of “2”, attribute setting unit 26 sets the line width to “thin”, the line type to “broken” and the line color to “black”, based on first association information 32.

Processing will be described next of attribute setting unit 26 in the case where time determination unit 25 determines that the contact time is not shorter than time T1. Attribute setting unit 26 sets, based on the input point number information and the color information in first association information 32, the color of a line to be used for drawing to a color based on detected input point number 33. For example, when detected input point number 33 has a value of “2”, attribute setting unit 26 sets the line width to “thin”, the line type to “solid” and the line color to “blue”, based on first association information 32.

Next, a description will be given of a case where attribute setting unit 26 sets a figure to be drawn. Based on count value 37 and second association information 36 in storage device 30, attribute setting unit 26 sets a figure to be drawn. For example, when count value 37 has a value of “4”, attribute setting unit 26 sets the figure to be drawn to a rectangle.

Referring again to FIG. 7, display control unit 27 will be described. Display control unit 27 causes display 12 to display various types of images. Display control unit 27 causes, for example, display 12 to display an image based on a user's operation, or display 12 to display an image in accordance with processing of CPU 101.

Further, based on setting of line attributes by attribute setting unit 26, display control unit 27 causes display 12 to display an image by means of the line having the set attributes and in accordance with input to touch panel 11. Namely, display control unit 27 causes display 12 to display an image in which a line having the attributes set by attribute setting unit 26 follows the trajectory of the touch position drawn by a user's touch operation after the attributes are set. Here, drawing information 311 of storage device 30 is a line image following the trajectory of the touch position.

Based on setting of a figure by attribute setting unit 26, display control unit 27 also causes display 12 to display an image in accordance with the set figure. The figure is displayed in the following manner described below.

Control unit 20 calculates the barycenter position (coordinate) based on each input coordinate of successively performed single-point input. Control unit 20 also calculates the distance between input coordinates. For example, in the case of FIG. 6(B), control unit 20 calculates the barycenter position with respect to position 91, position 92, position 93, and position 94. Control unit 20 also calculates the distance between position 91 and position 92, the distance between position 92 and position 93, the distance between position 93 and position 94, and the distance between position 94 and position 91. Control unit 20 then stores in storage device 30 the calculated barycenter position and each distance (input point interval distance).

Display control unit 27 determines the display position and the size of the set figure, based on barycenter position 38 and input point interval distance 39 stored in storage device 30.

For example, display control unit 27 displays a figure so that the barycenter position is the barycenter of the displayed figure. When count value 37 is “3” or “4”, for example, display control unit 27 displays a regular triangle or a square respectively having one side equal to the average of the input point interval distances. The way to display a figure by display control unit 27 is not limited to the one described above.

### Control Structure

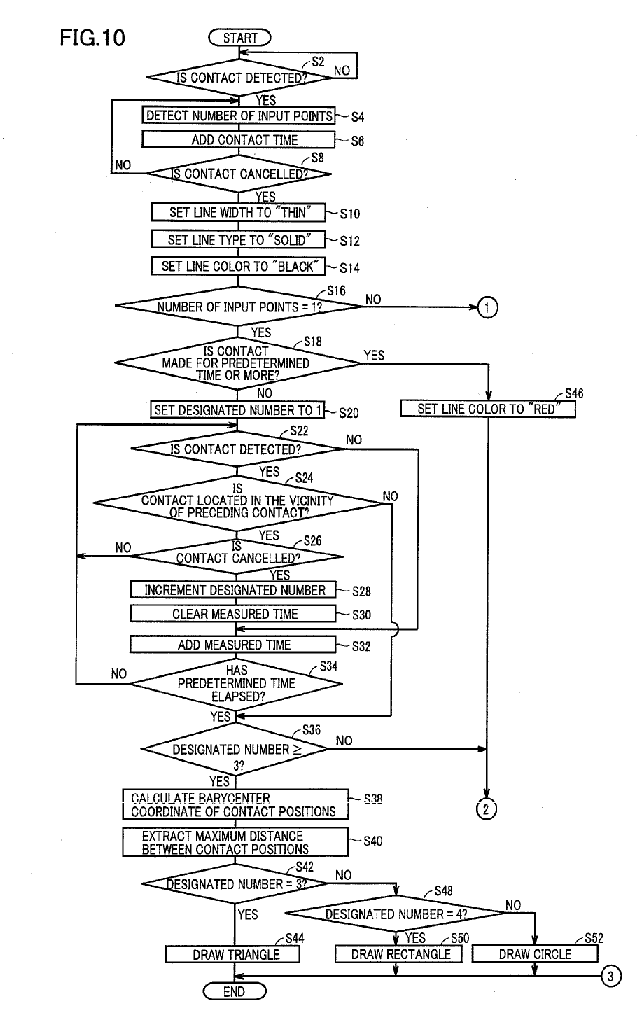

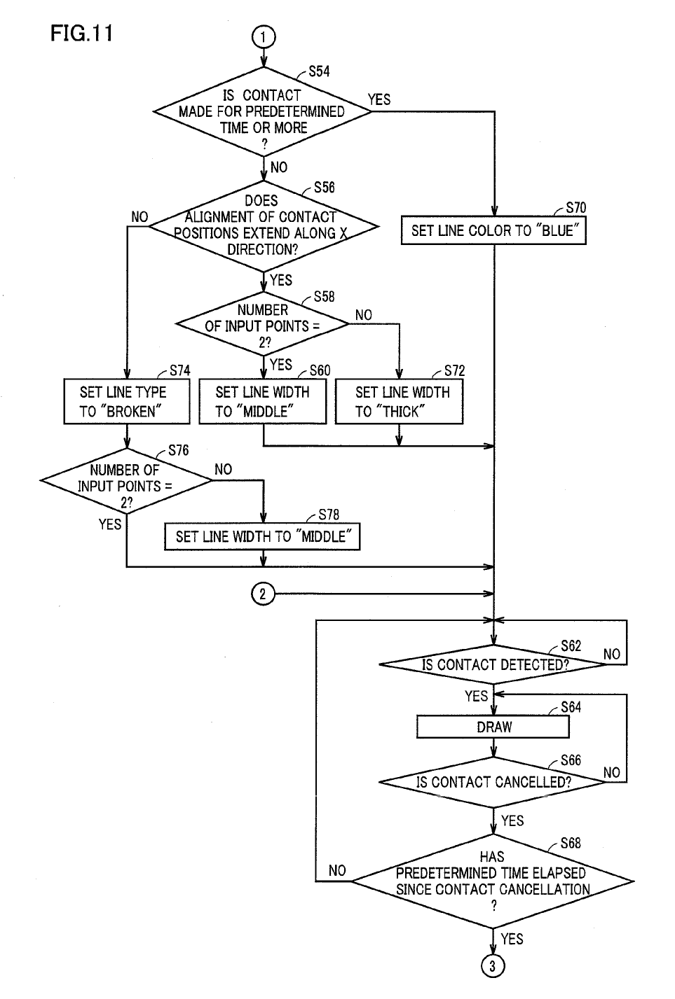

FIG. 10 is a flowchart showing a part of a flow of processing in electronic device 1. FIG. 11 is a flowchart showing a remaining part of the flow of the processing in the electronic device 1 that is not shown in FIG. 10.

Referring to FIG. 10, in step S2, electronic device 1 determines whether contact with touch panel 11 is detected. When the contact is detected (YES in step S2), electronic device 1 detects the number of input points of the contact in step S4. In contrast, when the contact is not detected (NO in step S2), electronic device 1 proceeds to step S2.

In step S6, electronic device 1 adds the contact time. Namely, electronic device 1 continues measuring the contact time. In step S8, electronic device 1 determines whether the contact is cancelled. When electronic device 1 determines that the contact is cancelled (YES in step S8), electronic device 1 sets in step S10 the line width of a line to be used for drawing to “thin”. In contrast, when electronic device 1 determines that the contact is not cancelled (NO in step S8), electronic device 1 proceeds to step S4.

In step S12, electronic device 1 sets the line type of the line to be used for drawing to “solid”. In step S14, electronic device 1 sets the color of the line to be used for drawing to “black”. In step S16, electronic device 1 determines whether the detected number of input points is 1. When electronic device 1 determines that the number of input points is 1 (YES in step S16), electronic device 1 determines in step S18 whether the contact is made for a predetermined time (time T1) or more.

Referring to FIG. 11, when electronic device determines that the number of input points is not 1 (NO in step S16), electronic device 1 determines in step S54 whether the contact is made for a predetermined time (time T1) or more. When electronic device 1 determines that the contact is made for the predetermined time or more (YES in step S54), electronic device 1 sets in step S70 the color of the line to be used for drawing to “blue”. Electronic device 1 thereafter proceeds to step S62.

When electronic device 1 determines that the contact is not the contact made for the predetermined time or more (NO in step S54), electronic device 1 determines in step S56 whether alignment of the contact positions extends along the x-axis direction. When electronic device 1 determines that the alignment extends along the x-axis direction (YES in step S56), electronic device 1 determines in step S58 whether the detected number of input points is 2. When the number of input points is 2 (YES in step S58), electronic device 1 sets in step S60 the line width of the line to be used for drawing (solid line in this case) to “middle”. In contrast, when the number of input points is not 2 (NO in step S58), electronic device 1 sets in step S72 the line width of the line to be used for drawing (solid line) to “thick”, Electronic device 1 proceeds to step S62 after step S60 and after step S72.

When electronic device 1 determines that the alignment does not extend along the x-axis direction (NO in step S56), electronic device 1 sets in step S74 the line type of the line to be used for drawing to “broken”. Namely, electronic device 1 changes the line type of the line to be used for drawing from the solid line set in step S12 to the broken line. In step S76, electronic device 1 determines whether the detected number of input points is 2.

When electronic device 1 determines that the number of input points is 2 (YES in step S76), electronic device 1 proceeds to step S62. At the time when the positive determination is made in step S76, the line width of the line to be used for drawing is “thin” as set in step S10. In contrast, when electronic device 1 determines that the number of input points is not 2 (NO in step S76), electronic device 1 sets in step S78 the line width of the line to be used for drawing to “middle”. Namely, electronic device 1 changes the line width of the line to be used for drawing from “thin” set in step S10 to “middle”.

In step S62, electronic device 1 detects contact with touch panel 11. When electronic device 1 detects the contact (YES in step S62), electronic device 1 performs drawing based on the contact on display 12 in step S64. When electronic device 1 does not detect the contact (NO in step S62), electronic device 1 proceeds to step S62.

In step S66, electronic device 1 determines whether the contact is cancelled. When electronic device 1 determines that the contact is cancelled (YES in step S66), electronic device 1 determines in step S68 whether a predetermined time has elapsed since the cancellation of the contact. In contrast, when electronic device 1 determines that the contact is not cancelled (NO in step S66), electronic device 1 proceeds to step S64.

When electronic device 1 determines that the predetermined time has not elapsed (NO in step S68), electronic device 1 proceeds to step S62. When electronic device 1 determines that the predetermined time has elapsed (YES in step S68), with reference to FIG. 10, electronic device 1 ends the processing.

When electronic device 1 determines in step S18 that the contact is made for the predetermined time (time T1) or more, electronic device 1 sets in step S46 the color of the line to be used for drawing to “red”. When electronic device 1 determines in step S18 that the contact is not the contact made for the predetermined time or more, electronic device 1 sets a designated number to “1”.

In step S22, electronic device 1 determines whether contact with touch panel 11 is detected. When electronic device 1 determines that the contact is detected (YES in step S22), electronic device 1 determines in step S24 whether the contact is made in the vicinity of the preceding contact position. When electronic device 1 determines that the contact is not detected (NO in step S22), electronic device 1 proceeds to step S32.

When electronic device 1 determines that the contact is made in the vicinity of the preceding contact position (YES in step S24), electronic device 1 determines in step S26 whether the contact is cancelled. When electronic device 1 determines that the contact is not made in the vicinity of the preceding contact position (NO in step S24), electronic device 1 proceeds to step S36.

When electronic device 1 determines that the contact is cancelled (YES in step S26), electronic device 1 increments the designated number in step S28. Specifically, electronic device 1 increases the designated number by only one. When electronic device 1 determines that the contact is not cancelled (NO in step S26), electronic device 1 proceeds to step S22.

In step S30, electronic device 1 clears the measured time. Namely, electronic device 1 resets (to zero) the value of the measured time. In step S32, electronic device 1 adds the measured time. Namely, electronic device 1 measures the time having elapsed since the clearing. In step S34, electronic device 1 determines whether a predetermined time (T2 as described above) has elapsed. When electronic device 1 determines that the predetermined time has elapsed (YES in step S34), electronic device 1 determines in step S36 whether the designated number is 3 or more. When electronic device 1 determines that the predetermined time has not elapsed (NO in step S34), electronic device 1 proceeds to step S22.

When electronic device 1 determines that the designated number is 3 or more (YES in step S36), electronic device 1 calculates in step S38 the barycenter coordinate of the contact position. When the designated number is 3 for example, electronic device 1 calculates the coordinate of the position of the barycenter with respect to the three contact positions. When electronic device 1 determines that the designated number is not 3 or more (NO in step S36), electronic device 1 proceeds to step S62 (see FIG. 11).

In step S40, electronic device 1 calculates the maximum distance between contact positions. In step S42, electronic device 1 determines whether the designated number is 3. When electronic device 1 determines that the designated number is 3 (YES in step S42), electronic device 1 draws a triangle on display 12 in step S44. In contrast, when electronic device 1 determines that the designated number is not 3 (NO in step S42), electronic device 1 determines in step S48 whether the designated number is 4.

When electronic device 1 determines that the designated number is 4 (YES in step S48), electronic device 1 draws a rectangle on display 12 in step S50. When the electronic device determines that the designated number is not 4 (NO in step S48), the electronic device draws a circle on display 12 in step S52.

As seen from the above, electronic device 1 is configured to include touch panel display 10 and excellent in drawing operation for users.

### Modifications

(1) While the foregoing description has been given of an exemplary configuration where the color of a line can be set in accordance with the contact time of a finger and the number of contact sites thereof, the color setting is not limited to this. Electronic device 1 may be configured without the capability of setting the color in accordance with the contact time of a finger and the number of contact sites thereof. In this case, it is unnecessary for electronic device 1 to make the determination about the contact time of a finger (step S18 of FIG. 10, step S54 of FIG. 11). Namely, in FIG. 8, the contact time is not required to be shorter than time T1.

In particular, electronic device 1 is preferably configured to allow a user to select ON or OFF of the capability of setting the color.

(2) Preferably, display control unit 27 causes display 12 to display the information about the line width, the line type and the line color of a line to be used for drawing in the form of icons, for example. Accordingly, a user can know, before performing drawing, what attributes a line to be displayed has, from the user's touch operation.

(3) The foregoing description has been given of an exemplary configuration where a finger is brought into contact with touch panel 11 to set the line width, the line type, the line color, and the figure to be drawn. Electronic device 1, however, may be configured so that the setting is done by an object such as stylus pen other than the finger.

(4) Preferably, electronic device 1 is configured so that contents of first association information 32 shown in FIG. 8 can each be changed based on a user's operation. Such a capability enables a user to customize the associating relation between the number of input points, the alignment of the input points, the line width, the line type, the line color, and the contact time. Further, first association information 32 is preferably registered for each user. In this case, even when electronic device 1 is used by multiple users, respective settings suited to individual preferences can be implemented by electronic device 1.

The number of input points based on which the line attributes are set may be defined more finely. For example, the first association information may be set so that the line width is “extra-thick” when the contact time is shorter than T1, the number of input points is “4”, and the alignment extends in the x-axis direction.

(5) Preferably, electronic device 1 is configured so that contents of second association information 36 shown in FIG. 9 can each be changed based on a user's operation. Such a capability enables a user to customize the associating relation between the number of times input is done and a figure. Further, second association information 36 is preferably registered for each user. In this case, even when electronic device 1 is used by multiple users, respective settings suited to individual preferences can be implemented by electronic device 1. While the input number of “5” or more is associated with a circle in FIG. 9, the input number may be defined more finely. For example, the input number “5” may be associated with a pentagon.

(6) As the touch panel display, an optical-sensor-integrated liquid crystal display may also be used.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electronic device comprising a touch panel display formed of a combination of a touch panel and a display, and accepting single-point input and multi-point input to said touch panel, said electronic device comprising:
a first detection unit configured to detect the number of input points to said touch panel, based on contact of an object with said touch panel;
a storage device storing first association information associating point number information about the number of input points with attribute information about an attribute of a line to be used for drawing;
a setting unit configured to set an attribute of said line to be used for drawing, based on said detected number of input points and said first association information; and
a display control unit configured to cause said display to display an image by means of said line having the set attribute and in accordance with input to said touch panel.

2. The electronic device according to claim 1, further comprising:
a second detection unit configured to detect a contact position of said object with said touch panel, based on contact of said object with said touch panel; and
a determination unit configured to determine, when said input points are multiple input points, and based on said detected contact position, whether alignment of detected contact positions extends along a predetermined direction, wherein
said attribute information includes line width information about a line width, and
when it is determined that said alignment extends along said predetermined direction, said setting unit sets, based on said point number information and said line width information, the line width of said line to be used for drawing to a width in accordance with said detected number of input points.

3. The electronic device according to claim 1, further comprising:
a second detection unit configured to detect a contact position of said object with said touch panel, based on contact of said object with said touch panel; and
a determination unit configured to determine, when said input points are multiple input points, whether alignment of detected contact positions extends along a predetermined direction based on said detected contact position, wherein
said attribute information includes line type information about a line type,
said line type information includes at least information about a first line type and information about a second line type, and
when it is determined that said alignment extends along said predetermined direction, said setting unit sets the line type of said line to be used for drawing to said first line type based on said line type information and,
when it is determined that said alignment does not extend along said predetermined direction, said setting unit sets the line type of said line to be used for drawing to said second line type based on said line type information.

4. The electronic device according to claim 3, wherein
said attribute information further includes line width information about a line width, and
said setting unit sets, based on said point number information and said line width information, the line width of said line to be used for drawing to a width in accordance with said detected number of input points.

5. The electronic device according to claim 1, further comprising a determination unit configured to determine whether the contact of said object is made for not less than a predetermined time, wherein
said attribute information further includes color information about a line color,
when it is determined that the contact of said object is made for not less than the predetermined time, said setting unit sets, based on said point number information and said color information, the color of said line to be used for drawing to a color in accordance with said detected number of input points, and,
when it is determined that the contact of said object is not made for not less than the predetermined time, said setting unit sets the color of said line to be used for drawing to a predetermined color.

6. The electronic device according to claim 1, further comprising a count unit configured to count the number of times said single-point input is successively performed in such a manner that, when a time interval between said single-point input and a subsequent single-point input is within a predetermined time, the subsequent single-point input is counted, wherein
said storage device further stores second association information associating said number of times with a figure to be used for drawing,
said setting unit sets a figure to be drawn, based on said counted number of times and said second association information, and
said display control unit causes said display to display an image in accordance with the set figure.

7. A display control method for an electronic device including a touch panel display formed of a combination of a touch panel and a display, and accepting single-point input and multi-point input to said touch panel, said display control method comprising the steps of:
detecting, by a processor of said electronic device, the number of input points to said touch panel, based on contact of an object with said touch panel;
setting, by said processor, an attribute of a line to be used for drawing, based on association information associating point number information about the number of input points with attribute information about an attribute of the line to be used for drawing, as well as said detected number of input points; and
causing, by said processor, said display to display an image by means of the line having the set attribute and in accordance with input to said touch panel.

8. A recording medium having a program recorded thereon for controlling an electronic device including a touch panel display formed of a combination of a touch panel and a display and accepting single-point input and multi-point input to said touch panel,
said program causing said electronic device to execute the steps of:
detecting the number of input points to said touch panel, based on contact of an object with said touch panel;
setting an attribute of a line to be used for drawing, based on association information associating point number information about the number of input points with attribute information about an attribute of the line to be used for drawing, as well as said detected number of input points; and
causing said display to display an image by means of the line having the set attribute and in accordance with input to said touch panel.
